(19) United States
(12) Patent Application Publication
(10) Pub. No.: US 2009/0120651 A1
(43) Pub. Date: May 14, 2009

(54) WATER POWERED FIREFIGHTING VEHICLE AND METHODS FOR USE

(76) Inventor: Bruce E. Schmutter, Brooklyn, NY (US)

Correspondence Address: THELEN REID BROWN RAYSMAN & STEINER LLP, PO BOX 640640, SAN JOSE, CA, 95164-0640, US

(21) Appl. No.: 12/116,793

(22) Filed: May 7, 2008

Related U.S. Application Data
(60) Provisional application No. 60/928,171, filed on May 7, 2007.

(51) Int. Cl. A62C 27/00; A62C 39/00

(52) U.S. Cl. 169/46; 169/24

(57) ABSTRACT

A self-misting, thermally and structurally fortified, water powered vehicle is provided as well as methods for its use in extinguishing and suppressing various types of fires.

### CROSS-REFERENCE TO RELATED APPLICATIONS

This application claim benefit of the U.S. Provisional Application Ser. No. 60/928,171, filed on May 7, 2007, which is incorporated by referenced herein. This application relates to U.S. application Ser. No. 11/528,181, filed Sep. 26, 2005, and U.S. Provisional Application Ser. No. 60/851,097, filed Oct. 11, 2006, which are incorporated by reference herein in their entirety.

### FIELD OF THE INVENTION

The present invention relates to a self-misting, structurally and thermally fortified, water powered vehicle and methods for its use in fighting fires.

### BACKGROUND OF THE INVENTION

Fires in the truss area of buildings, i.e., the space between the roof and the drop ceiling, present considerable danger to firefighters, and many fatalities have occurred from attempts to fight these types of fires. Prior to the present invention, firefighters could typically gain access to such fires from below, by piercing the drop ceiling, or from above by breeching the roof. Both of these options present unreasonable risks to the firefighter. Piercing the drop ceiling usually requires use of a long pole (pike) and a ladder, and the firefighter runs the risk of electrical shock or being injured by falling debris. Piercing the roof in order to access such fires presents the obvious risks of electrical shock, or of the roof collapsing under the firefighter. Further, both options present the hazard of exacerbating an existing fire by causing unnecessary ventilation if the access hole is pierced in the wrong place.

### OVERVIEW

The present invention meets the critical need for a safe and efficient method of fighting truss and other fires by providing a self-misting, water powered firefighting vehicle capable of quickly extinguishing or suppressing these fires. Because the vehicle itself, as well as all of the vehicle's on-board controls, are powered by water, the vehicle does not add a new source of fuel to the fire. Further, the self-misting, structurally and thermally fortified design of the vehicle keeps the operator of the vehicle safe from temperature extremes and falling debris.

The present invention provides a water powered vehicle for use in fighting fires. In one embodiment, the vehicle comprises a mast equipped with at least one multidirectional atomizer nozzle. In another embodiment, the mast comprises multiple atomizer nozzles, wherein each nozzle is adapted to provide adjustable direction of flow and rate of flow. In another embodiment, the vehicle comprises multiple atomizer nozzles capable of surrounding the vehicle in a water mist.

In another embodiment, the vehicle is adapted to be controlled remotely. In another embodiment, the vehicle is adapted to function within the facility/fireground management system described in U.S. application Ser. No. 11/528,181, filed Sep. 26, 2005, which is incorporated by reference herein in its entirety.

In an embodiment, the mast is a telescoping mast which can be adjusted (extended) from about 10 feet to about 40 feet. In another embodiment, the angle of the mast can be adjusted from about negative 10 degrees to 100 degrees from the chassis platform. The length of the mast can be extended at any angle. In a further embodiment, the mast can turn 360 degrees in any direction. In yet another embodiment, the mast comprises at least one high-pressure gatling-gun-type nozzle capable of piercing standard ceiling construction materials. The mast may be constructed of any suitable polymer or metal alloy. In one embodiment, the mast comprises a titanium alloy.

In a specific embodiment, the firefighting vehicle of the present invention comprises four wheels. In one embodiment, each wheel is powered by an individual water powered motor. In another embodiment, the wheels comprise treads. In specific embodiment, the treads comprise a thermally fortified material capable of withstanding temperatures of about 2000 degrees F. In one embodiment the tread material comprises Z-shield impregnated high temperature rubber threads. In yet another embodiment the wheels are independently suspended to allow the vehicle to be driven on a pitched and elevated surface. In one embodiment, the independent suspension allows the vehicle to navigate on a surface with 45 degree elevation and 45 degree pitch. The vehicle is capable of climbing or descending stairways.

In another embodiment, the chassis of firefighting vehicle of the present invention is adapted to be expandable such that the vehicle is capable of fitting through a standard door opening, and able to expand to provide increased stability when navigating areas of incline. In a specific embodiment, the chassis of the vehicle is expandable from about 24 inches to about 60 inches. In another specific embodiment, the vehicle is adapted to fit inside a typical Haz-Mat response vehicle, and weighs from about 300-800 lbs with empty tanks and from about 1000-1800 lbs with full tanks.

In an additional embodiment, the firefighting vehicle of the present invention is equipped with one or more on-board high pressure water storage tanks with internal nitrogen bladders used for both the water powered wheel motors and the self-misting system. In a specific embodiment, the high pressure water tanks are thermally fortified to withstand temperatures of about 2000 degrees F. In an embodiment, the high pressure water tanks are fortified with a Z-Shield blanket layer as described in U.S. Provisional Application Ser. No. 60/851,097, filed Oct. 11, 2006, which is incorporated by reference herein in its entirety. In another embodiment, the vehicle is equipped with an auxiliary tank containing a fire inhibiting composition such as by way of non-limiting example, a fire inhibiting solution or foam.

In another embodiment, the firefighting vehicle of the present invention comprises a coupling to accommodate an alternate power source. In one embodiment, the alternate power source is a high pressure water hose such as a standard two inch high pressure hose. In another embodiment, the vehicle is capable of recharging its on board water tanks via a high pressure hose.

In still another embodiment, the firefighting vehicle of the present invention is equipped with an emergency “bail out” tether to facilitate vehicle extraction from the fireground area. In another embodiment, the vehicle is equipped with a roll cage to protect the operator of the vehicle in the event of vehicle rolling and from falling debris. In a specific embodiment, the roll cage/vehicle cab is thermally fortified using, by way of non-limiting example, Z-shield shutter material as described in U.S. Provisional Application Ser. No. 60/851,097, filed Oct. 11, 2006, which is incorporated by reference herein in its entirety.

In one method of the present invention, the vehicle is deployed to extinguish a fire in the truss area of a building. In another method of the present invention, the vehicle is deployed between a burning building and a non-burning building to prevent the fire from spreading from the burning building to the adjacent non-burning building. In another method of the present invention, the vehicle is deployed to extinguish a chemical fire and prevent re-ignition of the fire. In another method of the present invention, the firefighting vehicle is deployed to extinguish a vehicle fire including but not limited to fires in or on cars, trucks, trains, aircraft or watercraft. In another method of the present invention, the vehicle is deployed in the fireground as a mobile sprinkler system to extinguish or suppress a fire.

Additional aspects of the present invention will be apparent in view of the description which follows.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 depicts a firefighter attempting access the truss area of a building by breaching the drop ceiling.

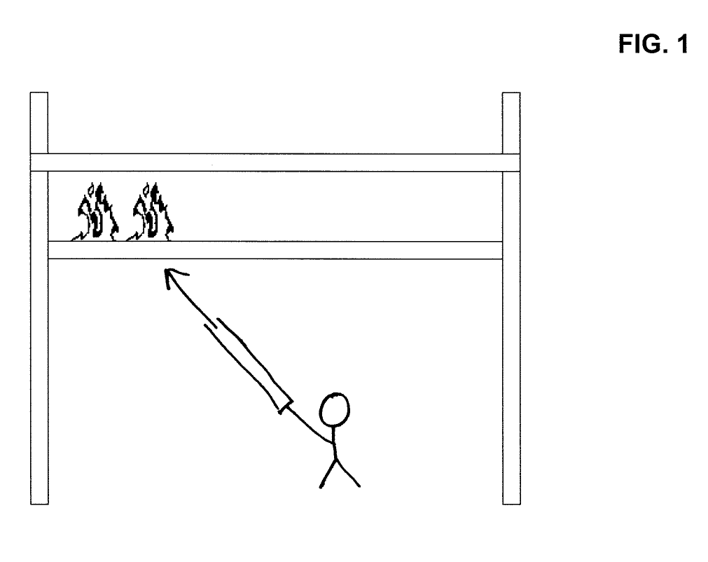

FIG. 2 depicts a firefighter attempting to access the truss area of a building by breaching the roof.

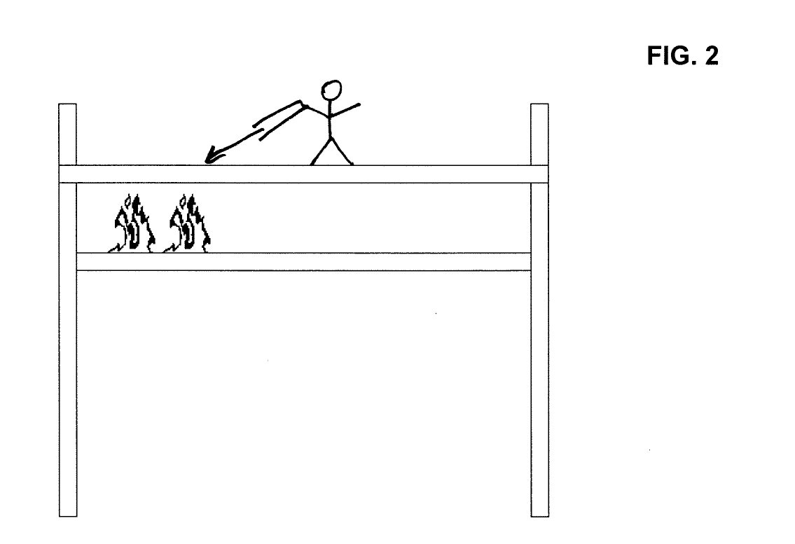

FIG. 3 depicts the water powered firefighting vehicle (including atomizing nozzle, gatling gun style nozzle, roll cage, and thermally fortified cab shutters) according to one embodiment of the invention. The vehicle's telescopic mast is being extended to pierce the ceiling of a building to access a fire in the truss area.

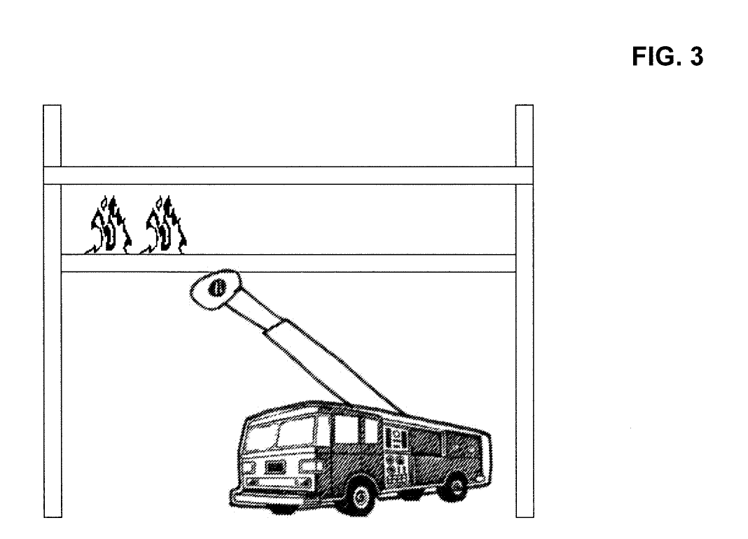

FIG. 4 illustrates the vehicle employing an atomizing nozzle at the end of the vehicle's mast to efficiently asphyxiate a fire in the truss area of a building.

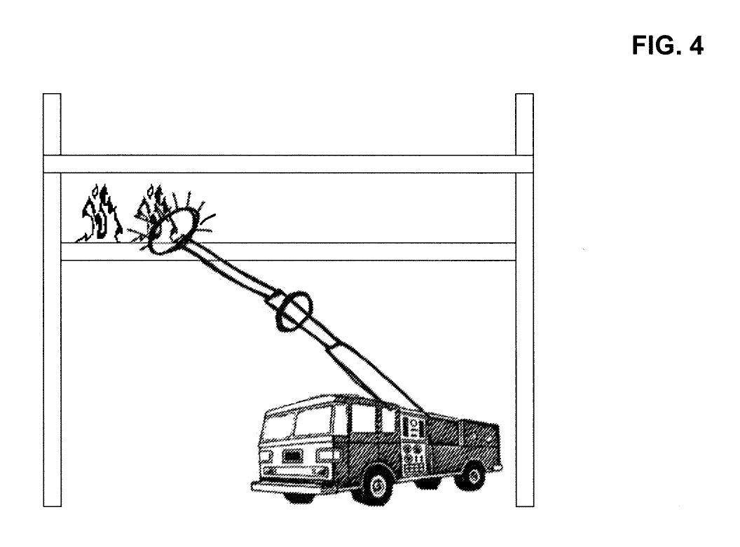

FIG. 5 shows the vehicle according to one embodiment of the invention employed to extinguish a vehicle fire.

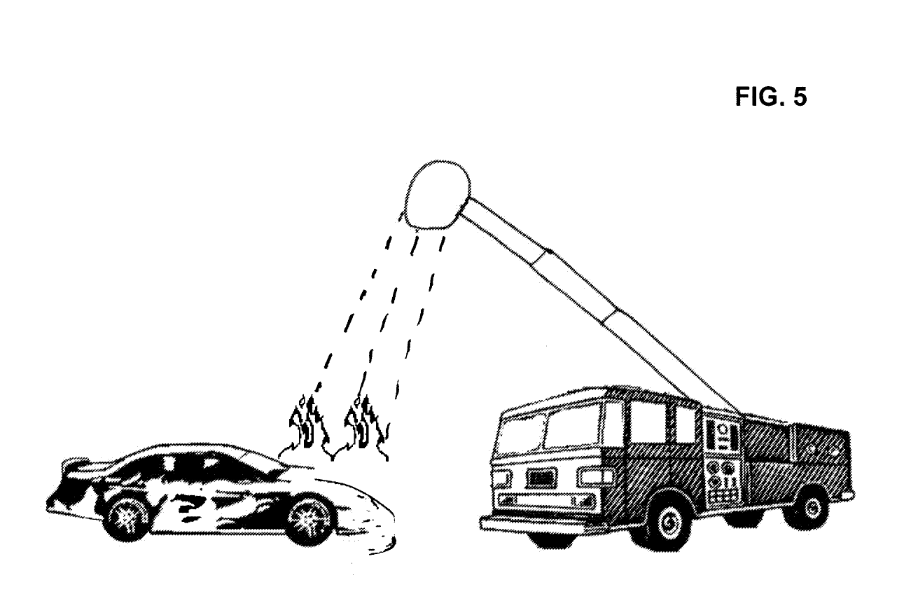

### DESCRIPTION OF EXAMPLE EMBODIMENTS

Embodiments of the present invention are described herein in the context of a method, system and apparatus for providing a self-misting, water powered vehicle and methods for its use. Those of ordinary skill in the art will realize that the following detailed description of the present invention is illustrative only and is not intended to be in any way limiting. Other embodiments of the present invention will readily suggest themselves to such skilled persons having the benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

### Example 1

The vehicle of the present invention is deployed in a strip mall fire. The vehicle is coupled to a standard 2 inch high pressure hose and enters the mall through a standard 36 inch wide door. Once through the door, the vehicle expands to 48 inches to increase navigation stability. As the vehicle proceeds to the fire it is propelled by water from the on-board tanks. Once the vehicle is in place e.g., below the truss fire, the vehicle operator will communicate to a pump track to “charge the system”. The mast will raise to the appropriate height and the operator will then use the piercing nozzles to safely penetrate the drop ceiling. The mast will then be raised into the truss space and the fire will be efficiently asphyxiated using an atomizing nozzle on the end of the mast.

During the entire time the firefighter is operating the vehicle both the firefighter and the vehicle is continuously misted with water and/or fire inhibiting solution from atomizing nozzles located throughout the vehicle. This functions to protect vehicle and operator from temperature extremes.

As the vehicle is progressing to another part of the fire, the ceiling collapses. The firefighter is protected from fire and hot debris by the thermally fortified shutters protecting the cab of the vehicle. The vehicle's reinforced roll bar also functions to protect the firefighter from falling debris. The firefighter communicates his dire situation to his team outside of the mall, and the vehicle is quickly extracted using the emergency tether system attached to the rear of the vehicle. The vehicle can also be equipped with a camera and remotely controlled from an area outside the fireground.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A water powered vehicle comprising a telescopic mast and at least one atomizing nozzle.

2. A method for fighting a fire using the vehicle of claim 1.
